(19) United States
(12) Patent Application Publication
(10) Pub. No.: US 2009/0182159 A1
(43) Pub. Date: Jul. 16, 2009

(54) APPARATUS AND METHOD FOR GENERATING CAVITATIONAL FEATURES IN A FLUID MEDIUM

(76) Inventors: Roman Gordon, Studio City, CA (US); Igor Gorodnitsky, Marina del Rey, CA (US); Sergio J. Lebid, Cleveland, OH (US)

Correspondence Address: KELLY LOWRY & KELLEY, LLP, 6320 CANOGA AVENUE, SUITE 1650, WOODLAND HILLS, CA, 91367, US

(21) Appl. No.: 12/144,539

(22) Filed: Jun. 23, 2008

Related U.S. Application Data
(63) Continuation of application No. 11/972,959, filed on Jan. 11, 2008, now abandoned.

(51) Int. Cl. C11B 1/00; C11C 3/04; B01J 19/00

(52) U.S. Cl. 554/9; 554/170; 422/129; 422/193

(57) ABSTRACT

A nano-cavitational generator for generating cavitational features in a fluidic medium. The generator is a static device that includes a series of chambers having varying diameters and flow areas to create variations in fluid velocity and pressure. The variations in fluid pressure create cavitational bubbles and eddies of internal pressure, which result in long-term, stable and ultra-thin emulsions and dispersions of the fluidic medium. The gas-liquid interface around the cavitational bubbles provides increased surface are for process reactions.

### FIELD OF THE INVENTION

The present invention is directed to an apparatus and method for producing methyl ester (biodeisel) fuel. More particularly, the present invention is directed to an apparatus and method for producing such bio-fuel using a flow-through cavitation generator with oils and animal fats. The present invention is also directed to an apparatus and method for creating hydrodynamic cavitation in fluids.

The present invention comprises an apparatus and method for processing hydrodynamic liquids via a static mechanical device that creates the fluid process of cavitation. The nature of cavitation allows for a final product of uniform emulsion and dispersion. The inventive apparatus may also have application in other areas of fluid processing, such as in chemistry, food and beverage, pharmaceutical, utility, refining, alternative/traditional fuel processing, experimental, and other fields of industry.

### BACKGROUND OF THE INVENTION

Biodiesel is methyl- or ethyl-ester, derived from vegetable oils and animal fats through the process of esterification, or more specifically transesterification. In such reactions, methanol (or ethanol) is added to vegetable oils or animal fats and processed together with a catalyst in a reactor. Transesterification is the process of using an alcohol, methanol or ethanol, in the presence of a catalyst, such as sodium hydroxide or potassium hydroxide, to chemically breakdown a molecule of raw renewable oil into methyl- or ethyl-esters of the renewable oil with glycerol as a by-product.

Systems are known in the field, i.e., batch systems, whereby a catalyst is mixed with methanol or where a methoxide solution is diluted with methanol in a mixing tank with oils or fats, i.e., waste oil. The alcohol solution is then added to a warm solution of the waste oil, and the mixture is heated, typically to about 50° C. and processes in a system for several hours, about 2 to 12 typically, to allow the transesterification to proceed. After the transesterification process, the mixture is left to stand to allow for separation of the biodiesel and glycerin. With this method, it takes approximately 5-10 hours for the glycerin to separate out of the mixture.

In a continuous biodiesel process, the same mixture of methoxide and methanol is present under high pressures (over 1000 PSI), within a pressure vessel. In such high pressure systems, the temperature of the oils and fats exceeds 50° C. Such a process requires large amounts of energy input, heavy equipment and a lot of foundation space.

In the processes mentioned above, the perfect solution for making methyl- or ethyl-ester, is to use feedstock that does not exceed 1% free-fatty acid (FFA). Also, economic feasibility requires utilization of two different alternatives for FFA removal during biodiesel production. High FFA content, in combination with conventional base-catalyzed transesterification, lowers the yield of biodiesel and produces by-products like soap stock and glycerin.

Two methods for removing FFA at different stages of biodiesel production are: i) caustic stripping or alkali refining of untreated poultry fat, which creates soap stock as a by-product and yields treated poultry fat that can be easily transesterified to biodiesel and glycerine (caustic pretreatment); and ii) a two-step process involving acid-catalyzed esterification followed by base-catalyzed transesterification, where the FFA is converted to biodiesel and subsequent transesterification yields additional biodiesel and glycerin.

Existing technologies that find application in the processing industries are similar in concept in that they all require an input source of energy to complete an equalization or homogenization process intended to produce a uniform and homogenous final product. For example, some existing technologies include a pressurized homogenizer, which uses a sequential valve assembly to increase fluid pressure in the material being processed to create ultra-thin emulsions and dispersions. Such a device requires large amounts of energy and also produces a very high outlet pressure, usually in excess of 5000 psi.

Cavitation is defined as the generation, subsequent growth and ultimate collapse of vapor- or gas-filled cavities in liquids resulting in very high energy densities on the order of 1 kW/m³ to 1018 kW/m³. As understood in this broad sense, cavitation includes the familiar phenomenon of bubble formation when water is brought to a boil under constant pressure. In engineering terminology, the term cavitation is used in a narrower sense, namely, to describe the formation of vapor-filled cavities in the interior or on the solid boundaries created by a localized pressure reduction produced by the dynamic action of a liquid system without a change in ambient temperature.

Cavitation can occur at millions of locations in a fluid body simultaneously and generate conditions of very high localized temperatures and pressures (a few thousand atmospheres in pressure and a few thousand Kelvin in temperature), with the overall environment at ambient conditions. Thus, chemical reactions requiring extreme conditions can be effectively carried out using cavitation while maintaining overall ambient conditions. Moreover, free radicals are generated during cavitation due to the dissociation of vapors trapped in the cavitating bubbles, which results in either intensification of the chemical reactions or in the propagation of certain other reactions. Cavitation also results in the generation of localized turbulence and liquid micro-circulation (acoustic streaming) in the reaction chamber, enhancing the rates of transport processes.

In homogenous reactions, both the products and reagents remain in solution. The mechanical effects of sonication do not play a part in such reactions. Instead the lesser understood part of cavitation comes into play, namely, the creation of radicals, radical ions and other high energy intermediates. The radicals, radical ions and other high energy intermediates act as a booster to overcome reaction energy barriers.

In heterogeneous liquid-liquid reactions, cavitational collapse at or near the liquid-liquid interface will cause disruption and mixing, resulting in the formation of very fine emulsions. When such emulsions are formed, the surface area available for the reaction between the two phases is significantly increased, thus increasing the rates of reaction. This is beneficial, particularly in the case of phase transfer-catalyzed reactions or biphasic systems.

TABLE 1
Comparison of energy efficiency for different techniques:

| Technique | Time (min) | Yield (%) | Yield/kJ energy |
|---|---|---|---|
| Acoustic | 10 | 99 | 8.6 × 10-5 |
| Hydrodynamic | 15 | 98 | 3.37 × 10-3 |
| Conventional with stirring | 180 | 98 | 2.7 × 10-5 |
| Nano-Flow-through | 8 | 99.9 | 2.6 × 10-3 |

It can be seen from Table 1 that reactions that take place in a flow-trough nano-cavitation generator are about 70 times more efficient compared to acoustic cavitation and 160 to 400 times more efficient compared to the agitation/heating/refluxing method.

Accordingly, there is a need for an apparatus and method to create ultra-thin, uniform emulsions and dispersions that does not require large amounts energy. Further, there is a need for such an apparatus and method that avoids potentially dangerous, high-pressure operation. The present invention fulfills these needs and provides further related advantages through the utilization of hydrodynamic cavitation and the chemical and physical reactions and process involved.

### SUMMARY OF THE INVENTION

The apparatus and method described herein does not require high input energy as the device is static, i.e., it does not contain any moving parts. The inventive apparatus simply requires a minimum input fluid velocity and pressure, and the chemistry of the fluid medium will be subject to the mechanical features of the device to create hydrodynamic cavitation towards the goal of creating ultra-thin or nano-scale emulsions and dispersions.

The inventive process is directed to a method for producing methyl- or ethyl-esters of oils or fats through a transesterification reaction. The process begins with mixing an alcohol with the oils or fats in the presence of a catalyst to form a fluidic medium. The methyl- or ethyl-esters comprise a biodiesel fuel. The catalyst comprises sodium hydroxide or potassium hydroxide. The alcohol comprises methanol or ethanol. The oils or fats comprise canola crude oil, rapeseed oil, soybean crude and soybean degumed oils, and beef tallow. In order to avoid the formation of soaps during the esterification reaction, the free-fatty acid (FFA) content of the oils or fats should not exceed five percent.

The fluidic medium is then introduced into a static reaction chamber with an initial fluid pressure. The static reaction chamber has a passageway therethrough. The fluidic medium is then passed through sequential compartments in the passageway. The compartments have varying diameters and inner surface features. The varying diameters and inner surface features cause the fluidic medium to undergo localized reductions in fluid pressure.

In a first preferred embodiment, the fluidic medium is flowed through sequential compartments of progressively smaller diameter. The progressively smaller diameters decrease the fluid pressure and generate cavitational fluid features in the fluidic medium. The fluidic medium may then be forced to flow around a conical cap positioned in the passageway such that the fluidic medium flows through a narrow circumferential opening. Flowing through this narrow circumferential opening further decreases the fluid pressure and generates additional cavitational fluid features in the fluidic medium. In addition, the fluidic medium may be forced to flow through orifices in a constrictor plate positioned in the passageway such that the fluidic medium flows through multiple narrow orifices. Flowing through these multiple narrow orifices further reduces the fluid pressure and generates even more cavitational fluid features in the fluidic medium.

In a second preferred embodiment, the fluidic medium is passed through an inlet orifice having a diameter much smaller than the diameter of the passageway. As with the orifices above, the fluid pressure is reduced and cavitational fluid features are generated in the fluidic medium. The fluidic medium is then passed through a first transition compartment having a first set of inner surface features. These inner surface features generate even more cavitational fluid features. The fluidic medium is then flowed into an impact compartment. In the impact compartment, the fluidic medium collides with an impact pad to create further cavitational fluid features. The fluidic medium then passes through an outlet orifice of diameter slightly larger than the inlet orifice. Such orifice begins the process of eliminating the cavitational fluid features, i.e., collapsing the bubbles and eddies of localized pressure and temperature. Finally, an outlet compartment having a second set of inner surface features restores the fluidic medium to the initial fluid pressure.

The reduction in the fluid pressure causes the fluidic medium to approaches the phasic liquid/vapor pressure threshold for the mixture. Once this phasic liquid/vapor pressure threshold is crossed, the fluidic medium begins to vaporize in local areas. This vaporization generates cavitational fluid features in the fluidic medium, including bubbles and localized elevations of temperature and pressure. The localized elevations of temperature and pressure increase the rate of the transesterification reaction.

The fluidic medium is then flowed through sequential compartments of progressively larger diameter. The progressively larger diameters increase the fluid pressure and restore the fluidic medium to the initial fluid pressure, thus eliminating cavitational fluid features in the fluidic medium. The fluidic medium is then restored to the initial fluid pressure to eliminate the cavitational fluid features.

Finally, the methyl- or ethyl-esters are separated from glycerin in the fluidic medium created during the transesterification reaction. The separating step may be accomplished by using a centrifuge or by allowing the glycerin to settle out of the methyl- or ethyl-esters.

An apparatus for producing methyl- or ethyl-esters of oils or fats through a transesterification reaction is directed to a nano-cavitation generator. The generator comprises a static reaction chamber having a passageway therethrough from an inlet to an outlet. The passageway includes sequential compartments moving from an inlet compartment adjacent the inlet to an outlet compartment adjacent the outlet. The sequential compartments have varying diameters and inner surface features. The outlet compartment has a diameter equal to a diameter of the inlet. When passing through the sequential compartments, a fluidic medium undergoes a decrease in fluid pressure to generate cavitational fluid features in the fluidic medium.

In a first preferred embodiment, the sequential compartments comprise a constriction compartment, a first reaction compartment, a second reaction compartment and a final reaction compartment. The constriction compartment, first reaction compartment and second reaction compartment each undergo a decrease in diameter relative to the previous compartment. The final reaction compartment and outlet compartment each undergo an increase in diameter relative to the previous compartment.

Also in the first preferred embodiment, a conical cap may be positioned in the constriction compartment such that a narrow circumferential opening is created between a wall of the constriction chamber and the conical cap. In addition, a constriction plate may be positioned in the first reaction compartment, the constriction plate having multiple narrow orifices. The second reaction compartment, final reaction compartment and outlet compartment may each include inner surface features, such as circumferential ridges, spiral ridges or randomly spaced protrusions or recesses in the walls of the compartments.

In a second preferred embodiment, the sequential compartments may comprise an inlet orifice, a first transition compartment having a first set of inner surface features, an impact compartment, an outlet orifice and an outlet compartment having a second set of inner surface features. The impact compartment includes an impact pad. The first and second sets of inner surface features comprise circumferential ridges, spiral ridges or randomly spaced protrusions or recesses in the walls of the compartments.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a first preferred embodiment of a nano-cavitation generator according to the present invention;

FIG. 2 is a cross-sectional side view of the first preferred embodiment of the nano-cavitation generator shown in FIG. 1;

FIG. 2a is an enlarged view of a portion of the reaction chamber passageway indicated by circle 2a in FIG. 2;

FIG. 3 is a perspective view of a nano-cavitation generator chamber and cap of the first preferred embodiment;

FIG. 4 is a cross-sectional view taken along line 4-4 of FIG. 3;

FIG. 5 is an exploded view of the nano-cavitation generator chamber and cap of FIG. 3;

FIG. 6 is a cross-sectional view of the nano-cavitation generator chamber taken along line 6-6 of FIG. 5;

FIG. 7 is a cross-sectional view of the nano-cavitation generator cap taken along line 7-7 of FIG. 5;

FIG. 8 is a partial cross-sectional view of the plasmator of the nano-cavitation generator;

FIG. 9 is a cross-sectional side view of the second preferred embodiment of the nano-cavitation generator of the present invention;

FIG. 10 is a perspective view of a nano-cavitation generator chamber and cap of the second preferred embodiment;

FIG. 11 is a cross-sectional view taken along line 11-11 of FIG. 10; and

FIG. 12 is an exploded view of the nano-cavitation generator chamber and cap of FIG. 10.

### DETAILED DESCRIPTION OF THE PREFERRED EMBODIMENTS

The present invention is directed to an apparatus and method for processing a liquid via a hydrodynamic cavitation process with the result being the creation of long-term stable and ultra-thin emulsions and dispersions. The cavitation process described herein is a mixing process at the molecular level within the described nano-cavitation generator. All components inside the apparatus are influenced by pressure impulses and advanced hydrodynamic cavitation. The device and method herein described follows the aforementioned chemical and physical reactionary process such that the device stimulates cavitation in hydrodynamic liquids to the point where the end result of processed fluid meets intended emulsification or dispersion criteria.

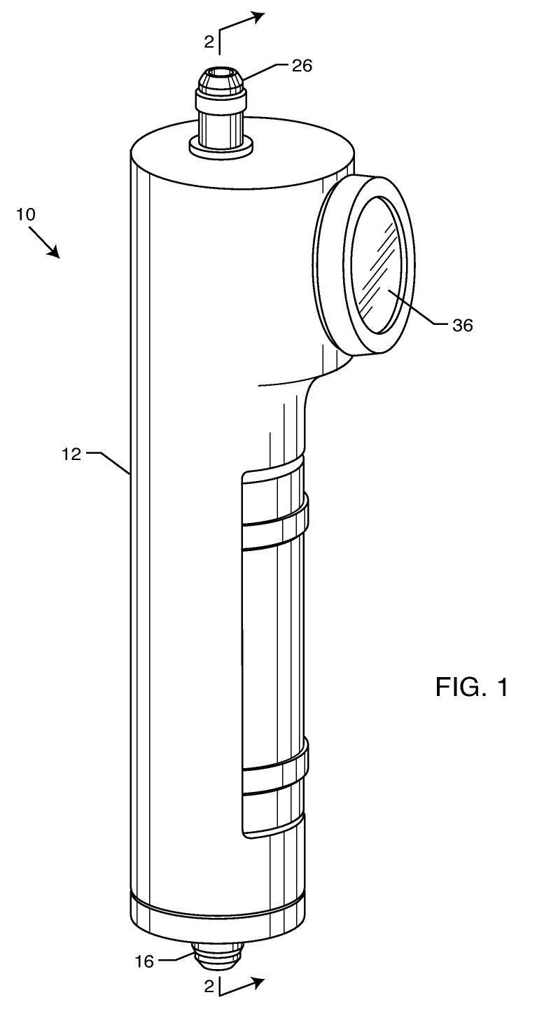

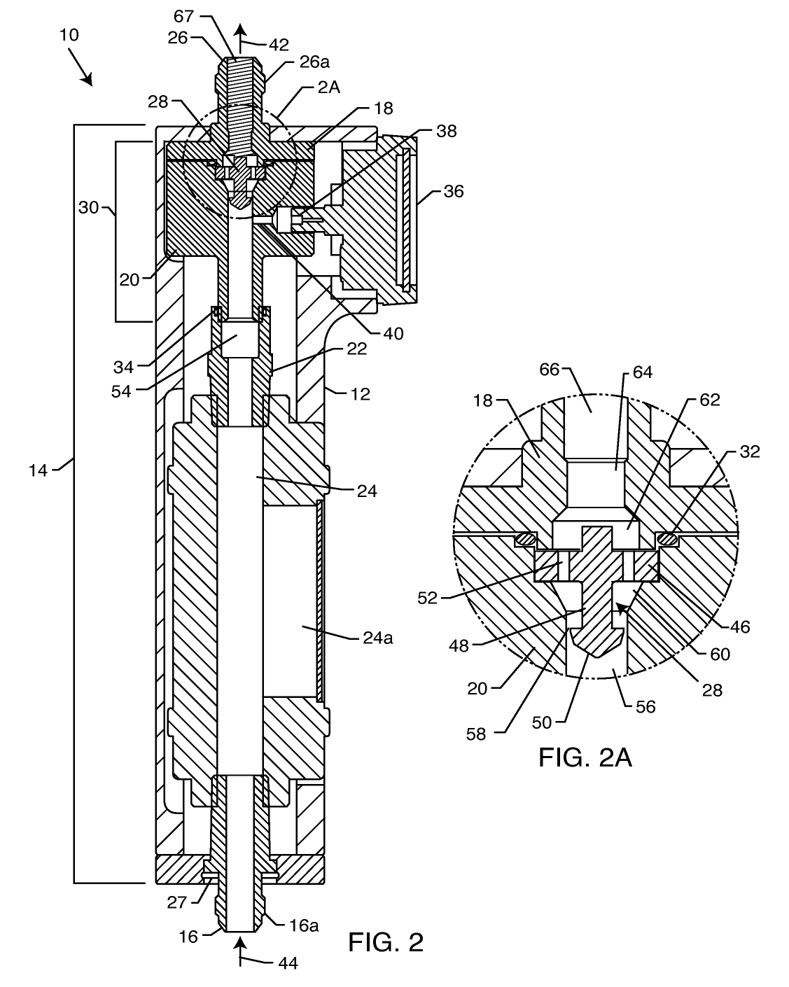

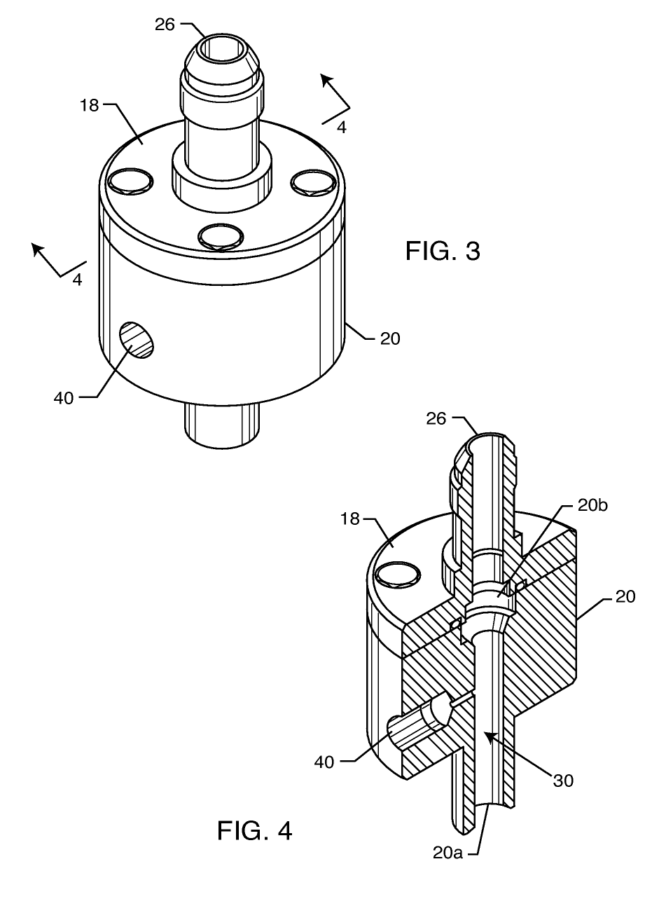

In the present invention, the reactor is a nano-cavitation generator 10. A nano-cavitation generator 10 is a novel piece of equipment that utilizes flow-through nano-cavitation technology for producing biodiesel fuel. As illustrated in FIGS. 1 and 2, the nano-cavitation generator 10 includes a casing or housing 12 which encloses a flow-through region 14. The flow-through region 14 comprises an inlet 16, a flowmeter passage 24, an intermediate coupling 22, a reaction chamber 20 having and inlet 20a and an outlet 20b, a reaction chamber cover 18, and an outlet fitting 26.

The inlet 16 is a fitting that passes through a portion of the housing 12. The inlet 16 includes a coupling 16a, whereby an external fluid line (not shown) is connected to supply a fluid medium or other reaction components to the generator 10. The inlet 16 is secured to the housing by a retaining ring 27 which holds the inlet 16 in place and provides sealing against leaks. The inlet fitting 16 is connected to a flowmeter passage 24 which includes a flowmeter 24a to measure the flowrate of process fluids. The flowmeter passage 24 is connected to an inlet 20a of the reaction chamber 20 by an intermediate coupling 22. The connection between the intermediate coupling 22 and the inlet 20a is sealed by an o-ring 34 or other similar structure. The reaction chamber 20 includes a reaction chamber passageway 30 that connects the inlet 20a to the outlet 20b. The reaction chamber cover 18 is connected to the reaction chamber 20 and partially defines the reaction chamber passageway 30. The outlet fitting 26 of the generator 10 is integral with the reaction chamber cover 18.

The reaction chamber passageway 30 defines a series of compartments having varying diameters and surface features. In a first preferred embodiment, as illustrated in FIGS. 2A thru 8, the series of compartments in sequence from the inlet 20a to the outlet 20b are as follows: inlet compartment 54, constriction compartment 56, first reaction compartment 60, second reaction compartment 62, final reaction compartment 64 and outlet compartment 66. A plasmator 28 is positioned in the passageway 30 through the constriction compartment 56 and the first reaction compartment 60. The configuration and operation of the plasmator 28 will be described below.

A number of the fittings and couplings in the generator 10 are sealed using retaining rings, o-rings or similar structures. The outlet fitting 26 includes an o-ring 32 which forms a water-tight seal in the junction between the outlet fitting 26 or reaction chamber cover 18 and the reaction chamber 20. Another o-ring 34 forms a water-tight seal in the connection between the reaction chamber 20 and the intermediate coupling 22. The connection between the intermediate coupling 22 and the flowmeter passage 24 should also be sealed by an o-ring or similar structure, as well as the connection between the inlet fitting 16 and the flowmeter passage 24. The inlet fitting 16 is retained and sealed against the housing 12 by a retaining ring 27 as described above.

A pressure gauge 36 is positioned in the housing 12 adjacent the reaction chamber 20. A sensor 38 from the pressure gauge 36 enters the reaction chamber 20 through an access passage 40. The pressure gauge 36 and sensor 38 are designed to measure the overall pressure in the reaction chamber 20. As discussed elsewhere, the overall pressure of the reaction chamber 20 should remain at about atmospheric pressure for the generator 10 to operate as intended.

The nano-cavitation generator 10 is static, i.e., contains no moving parts, and is configured for operation at a set fluid velocity and pressure of fluid medium. As described below, the changing of cavity diameters and surface features within the generator 10 causes the generation of cavitational fluid features, i.e., bubbles and localized elevations of temperature and pressure. These localized elevations of temperature and pressure come in the form of eddies of internal temperature and pressure increases. The subsequent collapse of the cavitational bubbles and eddies is such that the outlet liquid stream is homogenized into a stable, ultra-thin emulsion or dispersion.

The inventive device creates nano-cavitation in fluids in a flow-through region 14 between the fluid inlet fitting 16 and the fluid outlet fitting 26. The flow-through nano-cavitation reactor 10 is a multi-stage process whereby reaction components are manipulated through localized high temperature and pressure impulses and advanced nano-cavitation principles.

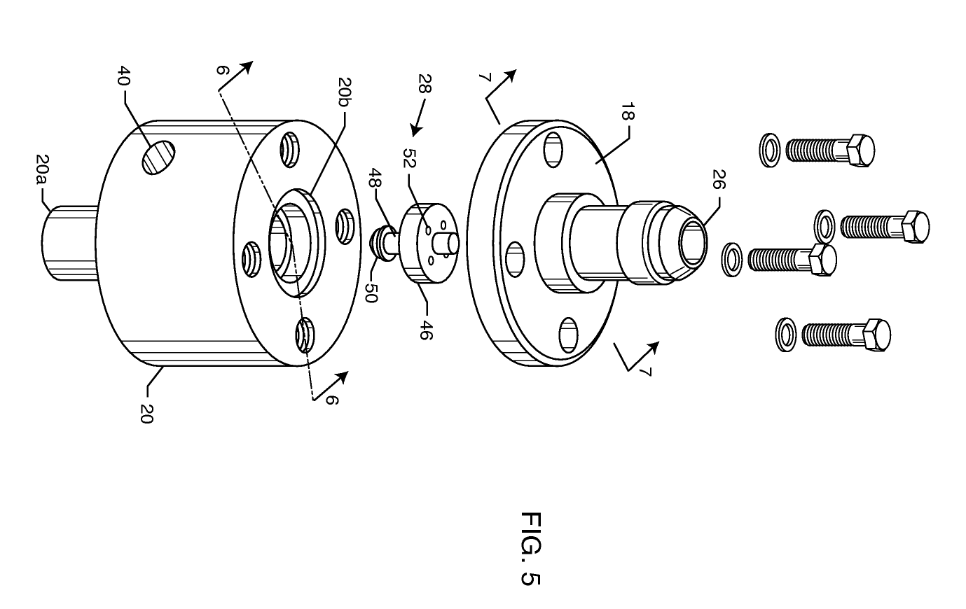

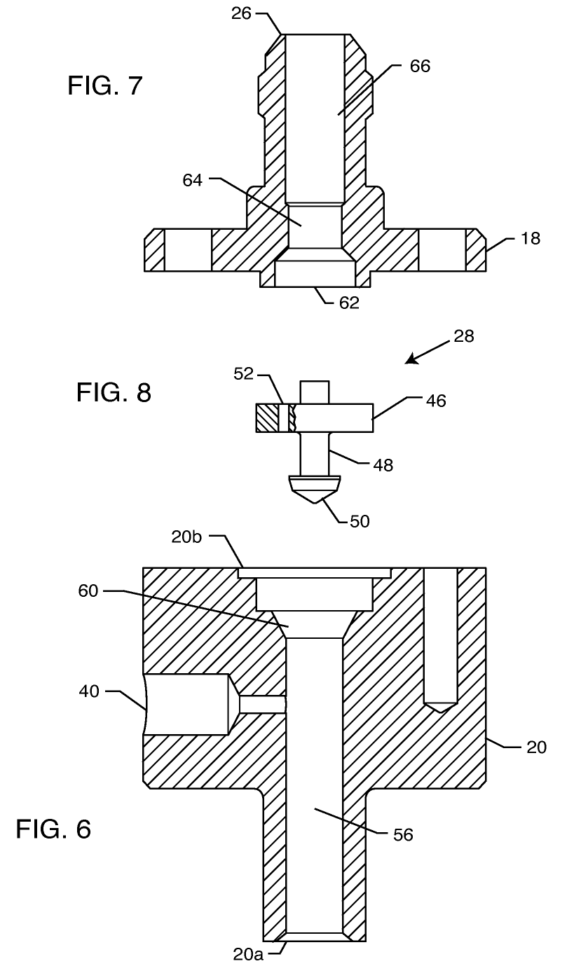

Fluid medium enters the generator 10 at the inlet fitting 16 as indicated by flow arrow 44. As described briefly above, the reaction chamber passageway 30 comprises various compartments of varying diameter and internal surface features such that the cross-sectional area of each changes in relation to the previous compartment, as illustrated in FIG. 2A. As illustrated in FIGS. 2A and 5, the plasmator 28 is positioned in the junction between the constriction compartment 56 and the first reaction compartment 60.

As illustrated in FIGS. 5 and 8, the plasmator 28 comprises a constrictor plate 46 having a stem 48 topped by a conical cap 50. A series of orifices 52 are positioned in the constrictor plate 46 around the stem 48. The plasmator 46 is oriented such that the conical cap 50 is centered in the constriction compartment 56 to force the fluid medium to an outer circumferential flow path 58, i.e., the gap between the wall of the constriction compartment 56 and the edge of the conical cap 50. The circumferential flow path 58 provides a greatly reduced flow area compared to the open flow area of the inlet compartment 54. This greatly reduced flow area leads to the nano-cavitational process described above. The orifices 52 in the constrictor plate 46 provide another point at which the available flow area is greatly reduced and the nano-cavitational process is increased. Finally, sequential compartments in the reaction chamber passageway 30 vary the available flow area and then match the flow area of the inlet fitting 16.

Processed fluid medium exits the generator 10 at the outlet fitting 26 as indicated by flow arrow 42. The nano-cavitational process takes place in the reaction chamber 20, specifically the reaction chamber passageway 30. The design of the nano-cavitation generator 10 and the theory behind the fluid process taking place is based solely on the static mechanical and physical construction of the device, i.e., the changing diameters, flow areas and cross-sectional areas.

All reactions that take place in the nano-cavitation generator 10 occur at ambient temperature. No agitation or mixing time is required. The nano-cavitational process is run at pressures between 100 psi and 1000 psi, ideally at around 500 psi. The nano-cavitation generator 10 produces an instant reaction process, due to the bonding at the molecular level of free fatty acids (FFA) in the oil or fat with the reaction catalysts. The transesterification process is completed in seconds and finished product is produced immediately. Complete separation of finished biodiesel and glycerin can be achieved within 8-15 minutes via gravitational processes and instantly via centrifugal processes.

While processing vegetable oils, yellow grease, tallow and other animal fats (below 5% percent FFA content) with necessary components in a flow-through nano-cavitator reactor 10, the molecules of FFA are broken apart in micro-explosions. Such micro-explosions result in instant glycerol separation, increased yield, decreased viscosity, increased cetane number, as well as, improvement of power parameters of produced fuel. The inventive generator 10 also increases the effectiveness of any catalysts used in the reaction, as well as, the rate and efficiency of the esterification reaction. Thus, the inventive apparatus not only increases the quality and quantity of pure biodiesel fuel output but also its production rate.

Flow-through nano-cavitation is produced by pressure variations, which are obtained using the geometry of the passageways in the reactor 10 creating variations in velocity and pressure. For example, based upon the geometry of the first preferred embodiment, an interchange of pressure and kinetic energy can be achieved resulting in the generation of cavities as in the case of the orifices 52 in the constrictor plate 46. The cavitating conditions are generated just after the orifices 52 in the reaction chamber passageway 30 and hence the intensity of the cavitating conditions strongly depends on the number and geometry of the orifices 52.

When the reaction liquid passes through the orifices 52, the flow velocities increase due to the sudden reduction in the area offered for the flow, resulting in a decrease in the pressure. In the inventive device, the velocities are increased such that the localized pressure drops below the vapor pressure of the liquid medium under operating conditions and cavities are formed. Such cavities are formed at multiple locations in the reaction chamber 20. The location of formation strongly depends upon the number of compartments and the configuration of the same in the reaction chamber passageway 30. However, downstream of the orifices 52, due to an increase in the flow area, the velocities decrease giving rise to increasing pressures and greater pressure fluctuations. The change in pressure and resultant pressure fluctuations control the different stages of cavitation, namely formation, growth and collapse.

The present invention makes it possible to accelerate the cavitational reaction causing bubbles to collapse and unite on a molecular level. The present invention also allows for the production of biodiesel fuel without the addition of large amounts of energy and avoids high-pressure operation. The present invention can produce biodiesel fuel using oils or fats with FFA content as high as five percent. Soaps formed during base catalyzed transesterification are not present after the cavitational transesterification process has been completed, provided the water and/or FFA content is not too high. This simplifies the separation of the product phases and prevents the formation of emulsions if a water wash procedure is used for the finished fuel.

One must be careful to monitor the amount of water and FFA in the biolipids (oil or fat) to be used in the inventive process. If the FFA or water level is too high, it may cause problems with soap formation and the separation of the glycerin by-product down stream. The separated glycerin may contain high levels of soap that make it difficult to produce a high-grade, industrial glycerin. Such problems may limit the possibilities for use of the end product.

Optimization data has shown that the transesterification reaction is accelerated by processing through the inventive generator 10. When using the generator 10, increasing the reaction temperature and increasing the amount of base catalyst is not necessary. Increasing the amount of base catalyst will increase soap formation, but as noted previously, these soaps are eliminated via the cavitational process.

The present invention employs a specific process for creating hydrodynamic cavitation in fluids. The process involves flowing the fluid through the cavitation generator 10. The inventive process begins with providing a cavitation generator 10 having a specified inlet velocity and system pressure through acceptable piping and pumping means according to the fluid medium being reacted. The inlet velocity and system pressure vary according to the fluid medium type and composition and supplying fluidic reaction components to the generator 10. Once the reaction components enter the generator 10 through inlet fitting 16, the flowrate is measured in the flowmeter passage 14. The preferred flow rate is approximately 10 gallons per minute, but may be adjusted lower or higher according to output requirements without affecting the results of the cavitation process. The preferred system pressure is between 100 psi and 1000 psi. In an esterification reaction where the reaction components are tallow (˜2.5% FFA), methanol and sodium hydroxide, the preferred inlet velocity is 10 gallons per minute and the preferred system pressure is about 500 psi.

After the flowmeter passage 14, the reaction components pass through the intermediate fitting 22 to the inlet 20a of the reaction chamber 20. The reaction components enter the inlet compartment 54 and experience an immediate increase in flow velocity and decrease in fluid pressure due to a reduction in diameter in relation to the inlet fitting 16. The reaction components pass into the constriction compartment 56 of slightly smaller diameter than the inlet compartment 54. The reaction components reach the conical cap 50 of the plasmator 28 centered to the flow path. As explained above, the conical cap 50 is solid in construction and only marginally smaller in diameter than the constriction compartment 56. The conical cap 50 forces the fluid medium to the outer perimeter of the constriction compartment 56 through the circumferential opening 58. This significant reduction in flow area causes a significant increase in fluid velocity and a significant decrease in fluid pressure. The resultant fluid pressure approaches the medium phasic liquid/vapor pressure threshold beginning the nano-cavitation process, i.e., causing the generation of cavities wherein vapor is suspended in the fluid medium.

After passing through this circumferential opening 58, the fluid medium will reach the first reaction compartment 60 which surrounds the stem 48 of the plasmator 28. The constrictor plate 46 is the far end of the first reaction compartment 60 and the fluid medium flows directly into the constrictor plate 60 which furthers the nano-cavitation process. The multiple orifices 52, preferably four, positioned about the stem 48 provide another greatly reduced flow path for the fluid medium, which further increases the fluid velocity and reduces the fluid pressure. The fluid medium is forced through the orifices 52 into the second reaction compartment 62 having a diameter slightly smaller than that of the first reaction compartment 60 but an open flow area. This open flow area begins the collapse of the cavitational fluid features. A final reaction compartment 64 enlarges the flow area to match the diameter of the inlet chamber 54. This increase in diameter causes a decrease in flow velocity and an increase in fluid pressure such that the cavities previously formed are collapsed and equalization/stabilization of the fluid flow occurs.

At this point, the fluid medium exits the reaction chamber 20 and passes into the outlet compartment 66 where the fluid flow stabilizes further and moves onto the outlet fitting 26. A set of surface features 67 cover the inner surfaces of the second reaction compartment 62, the final reaction compartment 64 and the outlet compartment 66. These surface features 67 comprise circumferential ridges, spiral ridges or randomly spaced protrusions or recesses in the walls of the compartments. The surface features 67 further add to the cavitational generation and collapse of fluidic features. From the outlet compartment 66, the fluid medium will pass from the outer chamber 66 to piping (not shown) or other similar structure by which the processed reaction components are passed from the cavitation generator 10.

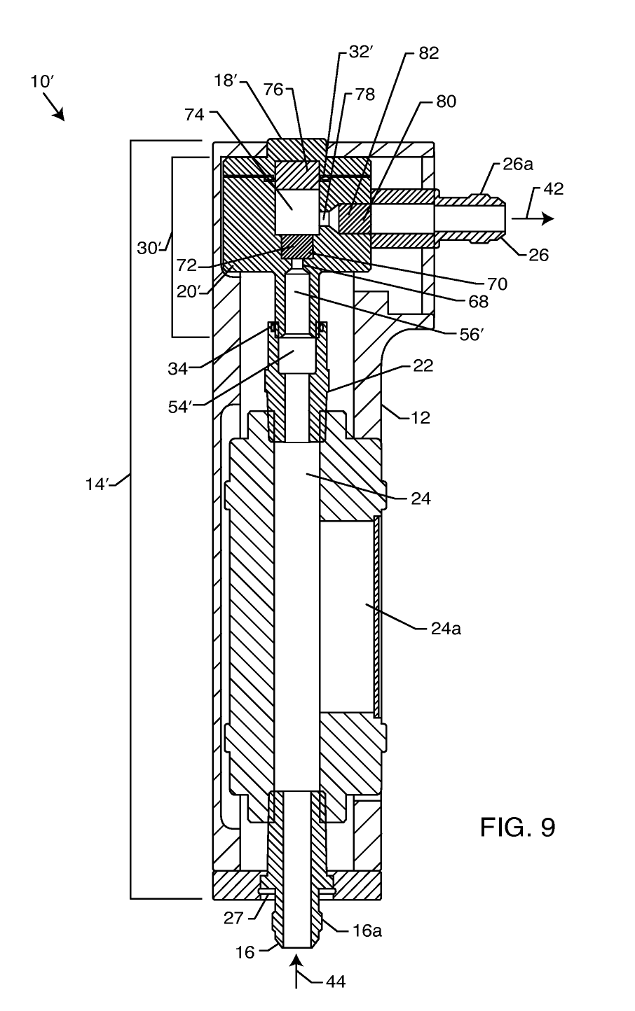

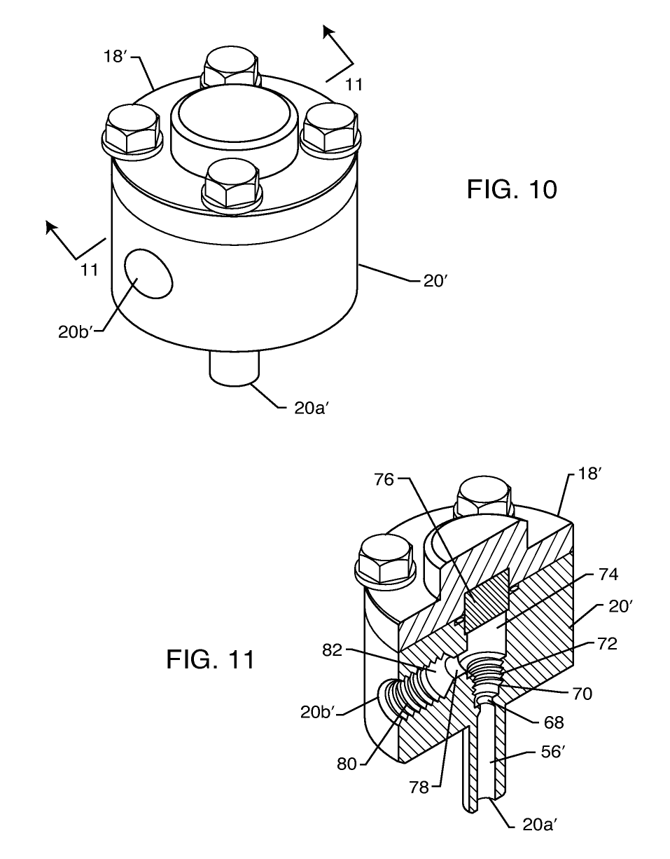

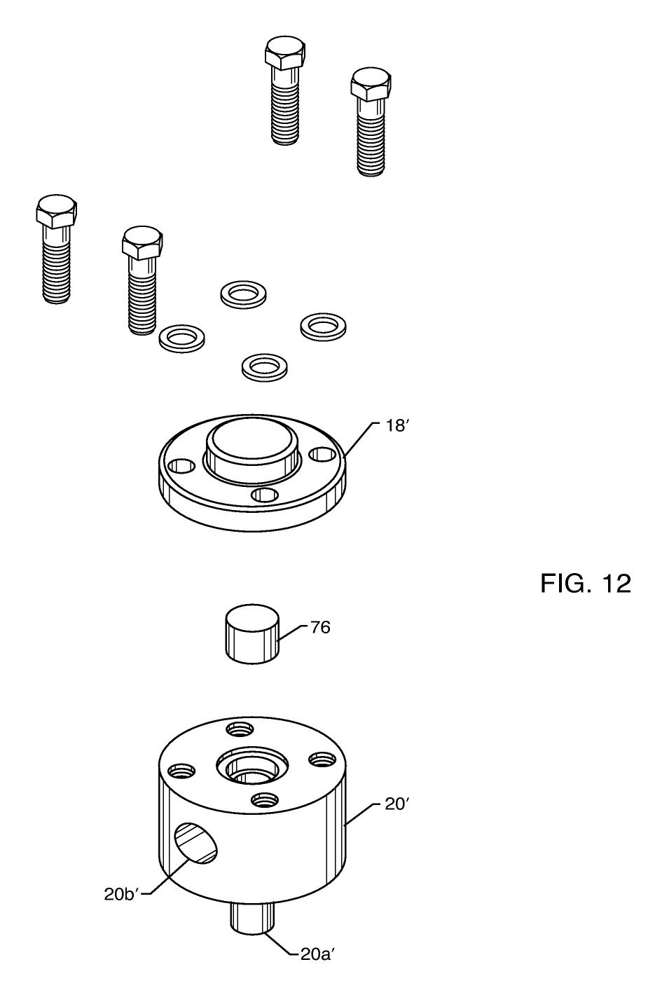

In a second preferred embodiment, the majority of the flow through region 14 is as described above in the first preferred embodiment. In the second preferred embodiment, the configuration of the reaction chamber 20′ and reaction chamber cover 18′ are as illustrated in FIGS. 9 thru 12. The series of compartments in sequence from the inlet 20a′ to the outlet 20b′ are as follows: a constriction compartment 56′, an inlet orifice 68, a first transition compartment 70, an impact compartment 74, an outlet orifice 78, and an outlet compartment 80.

The first transition compartment includes a first set of surface features 72 and the outlet compartment 80 includes a second set of surface features 82. As with the surface features 67 described above, the first and second sets of surface features 72, 82 further add to the cavitational generation and collapse of fluidic features. The second preferred embodiment includes an impact pad 76 positioned in the impact compartment 74. The impact pad 76 is placed opposite the opening from the first transition compartment 70 and provides a surface whereby the fluid medium is further agitated adding to the cavitational generation of fluidic features. As the fluidic medium passes through the outlet orifice, the cavitational fluidic features begin to collapse. As the fluidic medium exits the outlet compartment 80, the cavitational process is completed.

Using the prior art processes discussed above, test quantities of methyl- and ethyl-esters of five types of vegetable oils and animal fats were processed, characterized and ASTM performance tested. The vegetable oils and animal fats used as feedstocks for the methyl- and ethyl-esters include: canola crude oil (crude non-degumed canola oil with 3.2% FFA content), rapeseed, soybean crude and soybean degumed oils (soy oils with 1% to 1.4% FFA), and beef tallow (4.2% FFA). All of these products were also processed using the inventive generator 10 and method with only one pass through, producing similar if not better end product when compared to the prior art processes. Vegetable oils were processed under ambient temperature and beef tallow was processed at a temperature between 25° C. and 35° C.

The apparatus and method described herein, subject to the conditions and specifications of usage, provide a method for the processing and reacting of fluids to create emulsions and dispersions on the molecular level for the benefit of any trade or industry seeking to create such emulsions or dispersions. The processing is dependant upon the physical properties of the fluid being processed and the energy requirements based upon ambient conditions necessary to enact cavitation in the fluid.

The inventive method produces emulsions and dispersions of various liquids such that the final product is not limited in specification and performance. The inventive generator 10 may be used in any combination of single-pass, multi-pass, parallel flow, series flow, or other variations of deployment to render the desired result. As this patent applies to the chemical and physical nature of the process occurring within the device, the patent also covers any array of deployment or fluid circuitry allowable by such device.

Although several embodiments have been described in some detail for purposes of illustration, various modifications may be made without departing from the scope and spirit of the invention. Accordingly, the invention is not to be limited, except as by the appended claims.

1. A process for producing methyl- or ethyl- esters of oils or fats through a transesterification reaction, comprising the steps of:
mixing an alcohol with the oils or fats in the presence of a catalyst to form a fluidic medium;
introducing the fluidic medium to a static reaction chamber having a passageway therethrough, the fluidic medium having an initial fluid pressure;
passing the fluidic medium through sequential compartments in the passageway, the compartments having varying diameters and inner surface features such that the fluidic medium undergoes localized reductions in fluid pressure;
reducing the fluid pressure of the fluidic medium such that it approaches the phasic liquid/vapor pressure threshold;
generating cavitational fluid features in the fluidic medium, including bubbles and localized elevations of temperature and pressure;
restoring the fluidic medium to the initial fluid pressure to eliminate the cavitational fluid features; and
separating the methyl- or ethyl- esters from glycerin in the fluidic medium created during the transesterification reaction.

2. The process of claim 1, wherein the methyl- or ethyl- esters comprise biodiesel, the catalyst comprises sodium hydroxide or potassium hydroxide, the alcohol comprises methanol or ethanol, and the oils or fats comprise canola crude oil, rapeseed oil, soybean crude and soybean degumed oils, and beef tallow, all not to exceed 5% content of free-fatty acid.

3. The process of claim 1, wherein the passing step includes flowing the fluidic medium through sequential compartments of progressively smaller diameter, thus decreasing the fluid pressure and generating cavitational fluid features in the fluidic medium.

4. The process of claim 3, wherein the passing step includes flowing the fluidic medium through sequential compartments of progressively larger diameter, this increasing the fluid pressure, restoring the fluidic medium to the initial fluid pressure and eliminating cavitational fluid features in the fluidic medium.

5. The process of claim 1, wherein the passing step includes forcing the fluidic medium around a conical cap positioned in the passageway such that the fluidic medium flows through a narrow circumferential opening, thus decreasing the fluid pressure and generating cavitational fluid features in the fluidic medium.

6. The process of claim 1, wherein the passing step includes forcing the fluidic medium through orifices in a constrictor plate positioned in the passageway such that the fluidic medium flows through multiple narrow orifices, thus reducing the fluid pressure and generating cavitational fluid features in the fluidic medium.

7. The process of claim 1, wherein the passing step includes forcing the fluidic medium through a constriction compartment, an inlet orifice, a first transition compartment having a first set of inner surface features, an impact compartment having an impact pad, an outlet orifice and an outlet compartment having a second set of inner surface features.

8. The process of claim 1, wherein the separating step includes allowing the glycerin to settle out of the methyl- or ethyl- esters.

9. The process of claim 1, wherein the separating step includes removing the glycerin from the methyl- or ethyl- esters by centrifuge.

10. An apparatus for producing methyl- or ethyl- esters of oils or fats through a transesterification reaction, comprising:
a static reaction chamber having a passageway therethrough from an inlet to an outlet;
sequential compartments in the passageway moving from an inlet compartment adjacent the inlet to an outlet compartment adjacent the outlet;
the sequential compartments having varying diameters and inner surface features; and
the outlet compartment having a diameter equal to a diameter of the inlet.

11. The apparatus of claim 10, wherein a fluidic medium passed through the sequential compartments undergoes a decrease in fluid pressure to generate cavitational fluid features in the fluidic medium.

12. The apparatus of claim 10, wherein the sequential compartments comprise a constriction compartment, a first reaction compartment, a second reaction compartment and a final reaction compartment.

13. The apparatus of claim 12, wherein the constriction compartment, first reaction compartment and second reaction compartment each undergo a decrease in diameter with respect to the previous compartment.

14. The apparatus of claim 13, wherein the final reaction compartment and outlet compartment each undergo an increase in diameter with respect to the previous compartment.

15. The apparatus of claim 12, further comprising a conical cap positioned in the constriction compartment such that a narrow circumferential opening is created between a wall of the constriction chamber and the conical cap.

16. The apparatus of claim 12, further comprising a constriction plate positioned in the first reaction compartment, the constriction plate having multiple narrow orifices.

17. The apparatus of claim 12, wherein the second reaction compartment, final reaction compartment and outlet compartment each include inner surface features.

18. The apparatus of claim 17, wherein the inner surface features comprise circumferential ridges, spiral ridges or randomly spaced protrusions or recesses in the walls of the compartments.

19. The apparatus of claim 10, wherein the sequential compartments comprise an inlet orifice, a first transition compartment having a first set of inner surface features, an impact compartment, an outlet orifice and an outlet compartment having a second set of inner surface features.

20. The apparatus of claim 19, wherein the impact compartment includes an impact pad.

21. The apparatus of claim 19, wherein the first and second sets of inner surface features comprise circumferential ridges, spiral ridges or randomly spaced protrusions or recesses in the walls of the compartments.

22. A process for producing methyl- or ethyl- esters of oils or fats through a transesterification reaction, comprising the steps of:
mixing an alcohol with the oils or fats in the presence of a catalyst to form a fluidic medium;
introducing the fluidic medium to a static reaction chamber having a passageway therethrough, the fluidic medium having an initial fluid pressure;
passing the fluidic medium through sequential compartments in the passageway, the compartments having varying diameters and inner surface features such that the fluidic medium undergoes localized reductions in fluid pressure, wherein the passing step comprises the steps of: forcing the fluidic medium around a conical cap positioned in the passageway such that the fluidic medium flows through a narrow circumferential opening, thus decreasing the fluid pressure and generating cavitational fluid features in the fluidic medium; and forcing the fluidic medium through orifices in a constrictor plate positioned in the passageway such that the fluidic medium flows through multiple narrow orifices, thus reducing the fluid pressure and generating cavitational fluid features in the fluidic medium;
reducing the fluid pressure of the fluidic medium such that it approaches the phasic liquid/vapor pressure threshold;
generating cavitational fluid features in the fluidic medium, including bubbles and localized elevations of temperature and pressure;
restoring the fluidic medium to the initial fluid pressure to eliminate the cavitational fluid features; and
separating the methyl- or ethyl- esters from glycerin in the fluidic medium created during the transesterification reaction.

23. The process of claim 22, wherein the methyl- or ethyl- esters comprise biodiesel, the catalyst comprises sodium hydroxide or potassium hydroxide, the alcohol comprises methanol or ethanol, and the oils or fats comprise canola crude oil, rapeseed oil, soybean crude and soybean degumed oils, and beef tallow, all not to exceed 5% content of free-fatty acid.

24. The process of claim 22, wherein the passing step includes flowing the fluidic medium through sequential compartments of progressively smaller diameter, thus decreasing the fluid pressure and generating cavitational fluid features in the fluidic medium; and
wherein the passing step includes flowing the fluidic medium through sequential compartments of progressively larger diameter, this increasing the fluid pressure, restoring the fluidic medium to the initial fluid pressure and eliminating cavitational fluid features in the fluidic medium.

25. The process of claim 22, wherein the separating step includes allowing the glycerin to settle out of the methyl- or ethyl- esters; and wherein the separating step includes removing the glycerin from the methyl- or ethyl- esters by centrifuge.

26. A process for producing methyl- or ethyl- esters of oils or fats through a transesterification reaction, comprising the steps of:
mixing an alcohol with the oils or fats in the presence of a catalyst to form a fluidic medium;
introducing the fluidic medium to a static reaction chamber having a passageway therethrough, the fluidic medium having an initial fluid pressure;
passing the fluidic medium through sequential compartments in the passageway, the compartments having varying diameters and inner surface features such that the fluidic medium undergoes localized reductions in fluid pressure, wherein the passing step comprises the step of: forcing the fluidic medium through a constriction compartment, an inlet orifice, a first transition compartment having a first set of inner surface features, an impact compartment having an impact pad, an outlet orifice and an outlet compartment having a second set of inner surface features;
reducing the fluid pressure of the fluidic medium such that it approaches the phasic liquid/vapor pressure threshold;
generating cavitational fluid features in the fluidic medium, including bubbles and localized elevations of temperature and pressure;
restoring the fluidic medium to the initial fluid pressure to eliminate the cavitational fluid features; and
separating the methyl- or ethyl- esters from glycerin in the fluidic medium created during the transesterification reaction.

27. The process of claim 26, wherein the methyl- or ethyl- esters comprise biodiesel, the catalyst comprises sodium hydroxide or potassium hydroxide, the alcohol comprises methanol or ethanol, and the oils or fats comprise canola crude oil, rapeseed oil, soybean crude and soybean degumed oils, and beef tallow, all not to exceed 5% content of free-fatty acid.

28. The process of claim 26, wherein the passing step includes flowing the fluidic medium through sequential compartments of progressively smaller diameter, thus decreasing the fluid pressure and generating cavitational fluid features in the fluidic medium; and
wherein the passing step includes flowing the fluidic medium through sequential compartments of progressively larger diameter, this increasing the fluid pressure, restoring the fluidic medium to the initial fluid pressure and eliminating cavitational fluid features in the fluidic medium.

29. The process of claim 26, wherein the separating step includes allowing the glycerin to settle out of the methyl- or ethyl- esters; and
wherein the separating step includes removing the glycerin from the methyl- or ethyl- esters by centrifuge.
